(19) United States
(12) Patent Application Publication
(10) Pub. No.: US 2007/0132141 A1
(43) Pub. Date: Jun. 14, 2007

(54) Polymer molding process

(76) Inventor: Stanley A. Pleskunas, Watsonville, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/297,844

(22) Filed: Dec. 8, 2005

(51) Int. Cl. B29C 70/00

(52) U.S. Cl. 264/257; 264/324

(57) ABSTRACT

A molding process for a variety of structures including sports boards is provided. The process includes steps of: creating a three dimensional CAD image of a product, routing the inside edge of the product in a product blank, routing the outside edge of the product in two cassette halves, routing the product blank, inserting closeout material into the routed areas, shaping the product blank, shaping the cassette halves, placing outer skin material for the product in one cassette half, placing inner skin material for the product in the second cassette half, inserting the shaped product blank in the cassette half, placing inner skin material over the shaped product blank, placing outer skin material over the inner skin material, placing the second cassette half over said outer skin material, thereby forming a cassette package, placing the cassette package between contoured molded jaws, shaping the cassette package, and curing the product.

### BACKGROUND OF THE INVENTION

1. Field of the Invention

The present invention generally relates to the field of manufacturing processes. More specifically, this patent deals with a polymer molding process primarily used for the manufacture of sports boards including surfboards.

2. Description of the Related Art

The process of manufacturing fiber-reinforced products using a variety of different materials has been common practice for many years. Most common is the process of laying up of fiber glass reinforced products, such as boats, car bodies, and a wide variety of sports boards like surfboards, wind surfers, snow boards and the like. Although the manufacture of fiber reinforced products is commonplace, manufacturing costs and productivity ratios within certain specific industries are not at optimum levels. In the sports board manufacturing industry in particular, inefficient and burdensome manufacturing processes help to contribute to this lack of productivity and cost overrun. This present invention seeks to decrease cost and increase productivity primarily in the manufacture of fiber reinforced sports products by solving many of the inherent problems found in the conventional sports board manufacturing processes.

In the manufacture of sports boards, a builder will purchase a foam blank which is manufactured for a specific sized board. These blanks are molded to relatively close tolerances. The blank is then hand or computer machined into a finished shape. The hand shaping process results in an expensive and somewhat unrepeatable shape. In the case of CNC or computerized machining, the instability of the blank material used generally results in inconsistent production. The requirement for extended Z axis on computerized mills to accommodate the complex longitudinal sections of boards increases machine price and also increases the complexity of machine fixtures to index the blank on the CNC machine. Blanks manufactured specifically for boards are generally polystyrene, polyurethane or polyester foam. Existing construction techniques require the blank be finished by hand using woven glass and resin. Although effective, the result is fragile, expensive and time consuming. The existing finishing process is more of an art than a mass manufacturing process and so the results are inconsistent and expensive.

Generally, a very light foam core of ridged foam is used to create the shape. This is then glassed by hand in such a way that the rail portion or edges of the board are overlapped by two layers of glass. This means the layer on the bottom wraps around to the top of the board. The same goes for the layer on the top, which wraps to the bottom of the board. This offers a seamless edge, which is quite strong. For hand built conventional sports boards, this is the only way that is feasible to place the glass to make the board strong enough to withstand the rigors of normal use. This same technique can be used when building a sports board in a mold. However, it is difficult and time consuming to wrap the core with glass. Getting the sports board into the mold without wrinkling the overlap on one side or the other is difficult. When working with molds on conventional sports boards the normal practice is to withdraw the sports board from the mold and remove the glass or flash of resin and fiber outside of the sports board's finished shape. The seam on the rail is then reinforced with fiber and resin. This is a huge disadvantage, as the sports board requires finishing work after de-molding which is expensive and time consuming. Either way, hand glassing or molding, the result is an extremely brittle shell over fragile and ridged foam. The shape of the sports board and the nature of its use create a situation where about 90% of damage to the sports board occurs to its rail or edges. Although they are reinforced, the rail and edges are rigid and subject to fracture under impact.

Further, to provide strength and support for the board, internal structural supporting members called stringers are often used on most products fabricated in this manner. In addition, internal platforms are sometimes required where larger areas of strength are required. In most cases, these structures are rigid elements that are added to the foam core. The shaping of these rigid members adjacent to the soft foam core is often a difficult and burdensome process.

Therefore, because the manufacture of sports boards often requires time consuming and expensive manufacturing processes that are not suitable for mass production and products resulting from these conventional processes still remain inconsistent, substantially fragile, and brittle, it would be highly desirable to provide an efficient, productive, and cost-effective manufacturing process primarily used to mass produce a strong, flexible, and resilient sports board, but also additionally able to mass produce other fiber reinforced products as well as rigid products.

In this respect, before explaining at least one element of the invention in detail it is to be understood that the invention is not limited in its applications, or to the details of the sports board fabrication process and to the arrangement of the components set forth in the following description or illustrated in the drawings. The invention is capable of other similar fabrication processes and of being practiced and carried out in various ways. Also, it is to be understood that the phraseology and terminology of commercial products and parts employed herein are for the purpose of description and should not be regarded as limiting within the scope of this patent.

### SUMMARY OF THE INVENTION

The primary advantage of this invention is to create a process whereby a variety of products may be constructed by a new and unique molding process.

Another advantage of this invention is to create a process where both the product and the molding components are made from a variety of foam products.

A further advantage of this invention is to create a process where impermeable plastic or dense foam, referred to as closeouts, are used on the parting edges of the molding components.

And yet another advantage of this invention is to create a process where impermeable plastic or dense foam closeouts are used on the seam or as structural members within the product.

And still a further advantage of this invention is to design a product using CAD software, being able to flatten the product digitally to remove the longitudinal or extended contours.

Yet another advantage of this invention is to create a process where a product foam core is pre-shaped in a flat state.

Another advantage of this invention is to create a process where the foam core is placed in a two-part foam container referred herein as a cassette with a matching female cavity.

And still another advantage of this invention is to be able to be able to lay up the outer and inner skins either in the cassette or over the foam core along with any structural members and then seal the two halves of the cassette.

And yet another advantage of this invention is to be able to use preheated silicone sheet to accelerate curing time as well as a barrier between the wet glass and the cassette.

A further advantage of this invention is to be able to deform the cassette and internal product prior to curing between mold upper and lower foam mold jaws.

Another advantage of this invention is to create a process where the cassette is placed between mold jaws and pressed into additional desired contours.

A final advantage of this invention is to reduce the manufacturing costs and increase the productivity in the polymer molding processes.

The invention involves a molding process for a variety of structures including sports boards. The process includes steps of: creating a three dimensional CAD image of a product, routing the inside edge of the product in a product blank, routing the outside edge of the product in two cassette halves, routing the product blank, inserting closeout material into the routed areas, shaping the product blank, shaping the cassette halves, placing outer skin material for the product in one cassette half, placing inner skin material for the product in the second cassette half, inserting the shaped product blank in the cassette half, placing inner skin material over the shaped product blank, placing outer skin material over the inner skin material, placing the second cassette half over said outer skin material, thereby forming a cassette package, placing the cassette package between contoured molded jaws, shaping the cassette package, and curing the product.

In the first step of the process, CAD software is used to create a three dimensional digital image of a product and then flatten the structure longitudinally, minimizing the material required for a product blank. A groove is then routed in the product blank on the inside perimeter of the product. A segment of impermeable plastic or foam (closeout) is then inserted into the groove and the product blank is then shaped to the desired flat configuration. Two additional cassette blanks are then routed with grooves matching the outside of the perimeter of the product. Closeouts are then inserted into the groove, and a female impression is then removed from the two cassettes blanks with the closeouts reinforcing the parting line edge. If required, structural internal strength elements can be cut into the product blank, such as stringers, along with mounting fixtures for skegs and a leash. The function of the closeout in the product blank is to create a land surface for the top and bottom structural skins or laminates to adhere. This eliminates the need to lap the top and bottom glass to gain the strength required. In addition, this creates a much stronger and impermeable rail edge section. The closeout essentially minimizes damage to the rail by making it somewhat flexible and fracture resistant.

The next step in the process will be to lay up the outer skin of the product in the lower cassette. The materials suitable for this element include but are not limited to EVA (ethylene vinyl acetate) foam in various densities, polyethylene, PVC (poly vinyl chloride, polyester or any material that will bond and have physical characteristics, which allow its use in the molding process. The outer skin element serves several functions. The outer skin serves as a barrier between the cassette and inner skin. The function as a barrier keeps bonding resins or agents from contacting the mold during construction. This allows elimination of expensive and time-consuming mold preparation. This also allows the use of non-traditional mold materials, which are normally hard and non-porous. The mold material can be flexible, semi rigid, rigid, porous or non-porous with the use of the outer skin as a mold barrier. A sheet of preheated silicone can also be used for the outer skin producing the same features while also accelerating the curing time of the product.

The inner skin is then laid over the outer skin in the lower cassette. This element is the structural skin for the deck surface of the board. It can be but is not limited to a fiber-reinforced matrix. The fibers can be natural, carbon, glass, arimid (Kevlar) or any fiber suitable for the application. The resins can be but are not limited to polyester, epoxy, acrylic urethane or any resin suitable for the application. The inner skin can be fiber reinforced thermal plastic. This plastic can be but is not limited to PVC, ABS, Polycarbonate, polyethylene or any plastic suitable for the application. The inner skin can be un-reinforced thermal plastic. It can be PVC, ABS, Polycarbonate, polyethylene or any other polymer suitable for the application.

The shaped product blank is then placed in the lower cassette. All internal strength members will have one or more layers of the same material as the inner skin with the skin extending past the edges of the internal strength member. The core of the internal strength members will then be inserted. The stringer core can be but is not limited to Polypropylene foam, polyethylene foam, Styrofoam, PVC foam, urethane foam, epoxy foam or any other foam suitable for the application. The skin of the internal strength members must extend past the edges because greater structural rigidity can be achieved by bonding with the inner skin of the product. The inner skin and the outer skin of the product are then placed over the product blank and covered by the upper cassette.

The two molds jaw halves reflect the additional dimensional curve of the product. The flexibility of the cassette and core of the board allow the cassette to be loaded with the materials which are included in the finished product and then bent to the finished product shape in the molds. The assembly is placed in the mold under pressure while the resin and/or glue are in a liquid state. The assembly is left in the mold until the resin has cured. This leaves the cured finished product with the final design elements. The molds jaws can then be closed and pressure is applied to the cassette assembly with the use of screws, air pressure (bladders or cylinders), weight, hydraulic (bladders or cylinders), vacuum or clamps of any kind. Air pressure within a bladder or bladders is preferred because of the low cost and cleanliness of this method. In addition, the pressure applied through the use of an air bladder is evenly distributed over the face of the molds. When the pressure is evenly distributed, the material used for the molds can be foam of several different types.

Once the board has been removed from the mold, the residual flash can be removed. Utilizing the closeout in the molding process also eliminates the need for reinforcement of the rail seam after the board is removed from the mold. This saves time and materials and increases the strength of the product, making the closeouts crucial to building molded products. The closeout can then be placed anywhere on the section of the board as long as it intersects the mold parting line. This design has beneficial effect on the strength of the board along with simplifying the manufacturing processes.

Although the process described above is primarily used for sports boards such as surfboards, this process can be used to manufacture a wide range of similar lightweight products with extreme and exaggerated contours that have a great deal of structural integrity, for example aircraft components and parts for small boat construction, and still remain within the scope of this invention.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of, this specification illustrate embodiments of the invention.

FIG. 1 depicts an exploded perspective view of a typical section through the edge of a sports board using the polymer molding process, constructed in accordance with the present invention;

FIG. 2 depicts a cross-section through the original product blank with grooves routed for the closeout, constructed in accordance with the present invention;

FIG. 3 depicts a cross section of the product blank in the desired configuration with the original product blank in phantom, constructed in accordance with the present invention;

FIG. 4 depicts a cross-section exploded view illustrating the lower cassette, the lower outer skin, the lower inner skin, the product blank, the upper inner skin, the upper outer skin, and the upper cassette, constructed in accordance with the present invention;

FIG. 5 depicts a cross section through the cassette assembly package, constructed in accordance with the present invention;

FIG. 6 depicts a product manufacturing flow diagram, following the process in accordance with the present invention;

FIG. 7 depicts an exploded perspective view of the elements used in the fabrication of a sports board, constructed in accordance with the present invention;

FIG. 8 depicts an exploded side view of the cassette assembly package between the lower mold jaw and the upper mold jaw, constructed in accordance with the present invention;

FIG. 9 depicts a side view of the cassette assembly compressed between the mold jaws, constructed in accordance with the present invention;

FIG. 10 depicts an exploded view of the product blank with the central segment removed, constructed in accordance with the present invention;

FIG. 11 depicts a cross-section view of the product blank with a centrally located large strength member, constructed in accordance with the present invention; and

FIG. 12 depicts an exploded view of the product blank with typical stringer and skeg mounts, constructed in accordance with the present invention.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

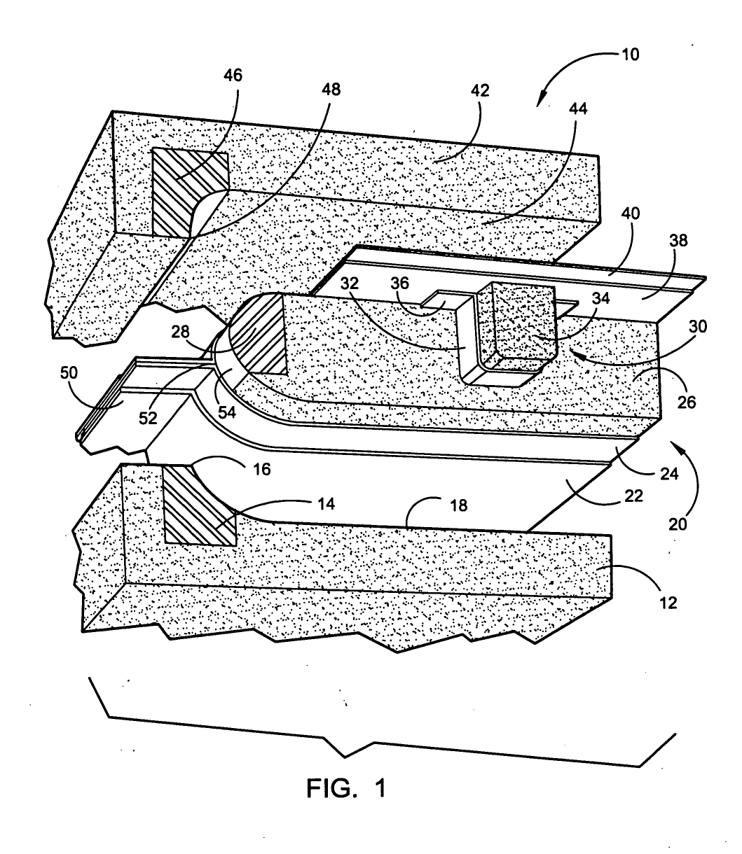

Referring now to the drawings, wherein similar parts of the polymer molding process 10 are identified by like reference numerals, there is seen in FIG. 1 an exploded perspective view of a typical section through the edge of a sports board using polymer molding process 10. A lower cassette 12 is shown with a closeout 14 and a parting line edge 16 in cross-section. Parting line edge 16 is where most of the wear occurs during the process. A lower female impression 18 receives a product assembly 20. Product assembly 20 consists of a lower outer skin 22 and a lower inner skin 24 below a product blank 26. Product blank 26 is shown with a closeout 28 shown in cross-hatch with a typical stringer unit 30 having a skin 32 and a central core 34 with an extended skin 36 attached to an upper inner skin 38. An upper outer skin 40 is laid over the upper inner skin 38. An upper cassette 42 has an upper female impression 44. Upper cassette 42 has a similar closeout 46 to closeout 14 in lower cassette 12, with a parting line edge 48. A residual flash 50 extends from a parting line 52 of product assembly 20 to be removed after product removal from cassette halves 42 and 12. Parting line 52 is adjacent to the exterior surface 54 of product closeout 28.

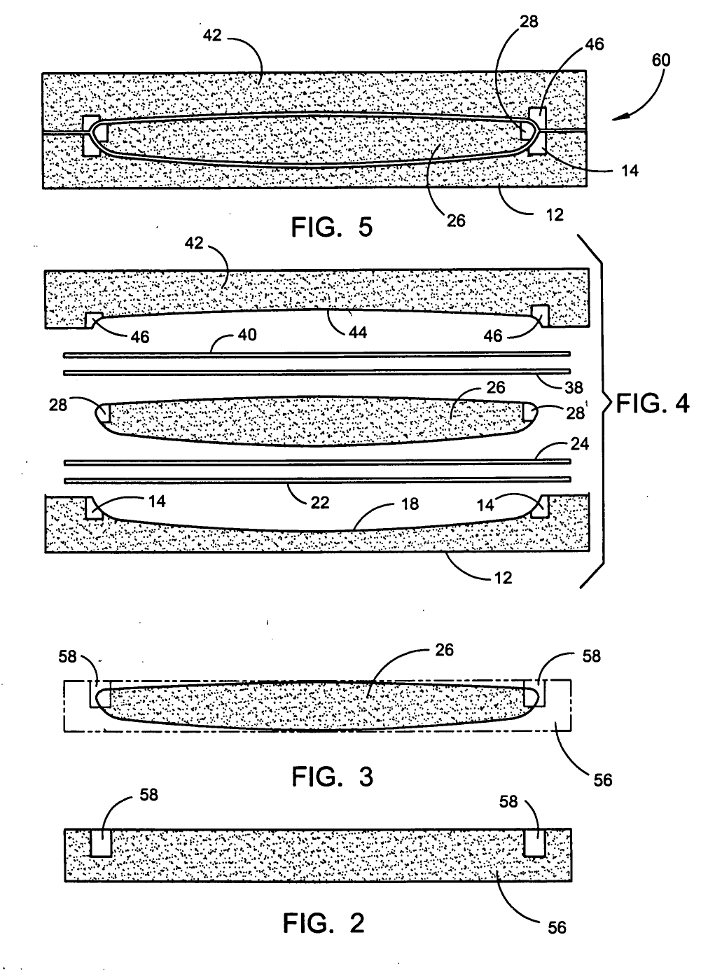

As illustrated in FIG. 2, there is seen a cross-section view through original product blank 56 with grooves 58 routed for closeout 28 (see FIG. 5).

As illustrated in FIG. 3, there is seen a cross-section view of product blank 26 in the desired configuration with original product blank 56 shown in phantom.

As illustrated in FIG. 4, there is seen a cross-section exploded view of a cassette assembly package 60, illustrating the spatial relationship between lower cassette 12, lower outer skin 22, lower inner skin 24, product blank 26, upper inner skin 38, upper outer skin 40, and upper cassette 42.

As illustrated in FIG. 5, there is seen a cross-section through a cassette assembly package 60.

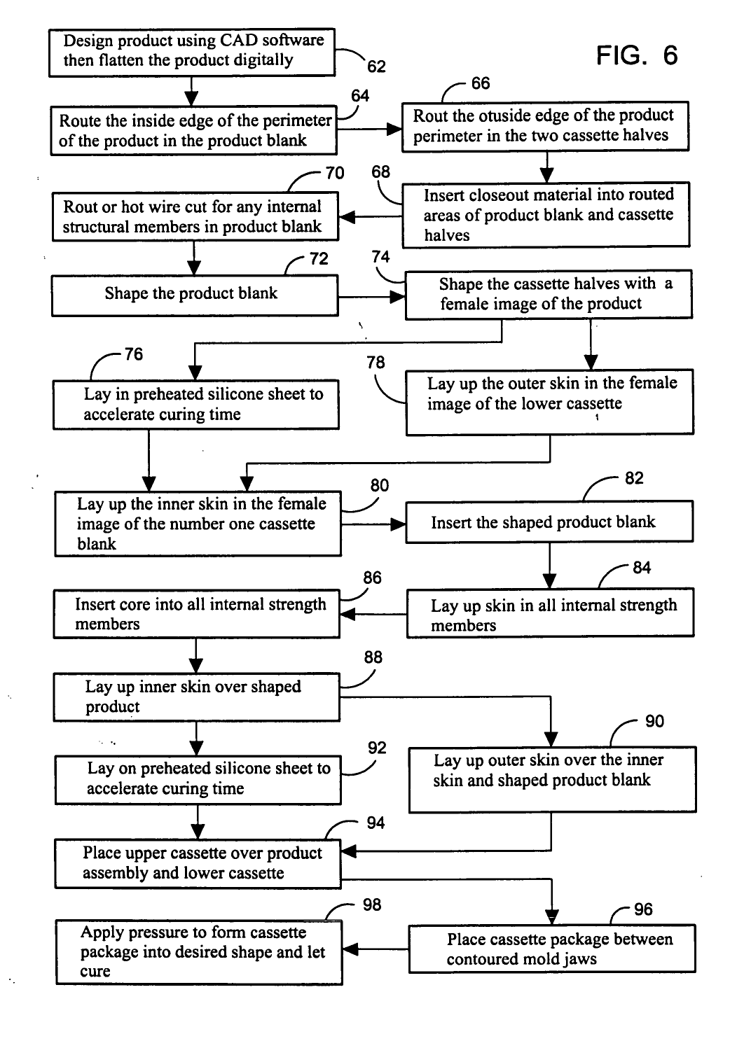

As illustrated in FIG. 6, there is seen a product manufacturing flow diagram. Initially, the product is designed using CAD software and then digitally flattened, represented in step 62. The inside edge of the product 26 is then routed in original product blank 56 shown in step 64 and then the outside of the product perimeter is routed in the two cassette halves 12 and 42, represented in step 66. Closeout material then is inserted in the routed areas of original product blank 56 and cassette halves 12 and 42, represented in step 68. All internal structural members are then routed or hot wire cut into product blank 26, represented in step 70. Next, original product blank 56 will be finish shaped as indicated in step 72. Both the upper and lower cassette halves 12 and 42 will have the female impressions 18 and 44 shaped into them, represented by step 74. The lower outer skin 22 is then laid in the lower female impression 18 in the lower cassette 12, represented in step 76, with the option of using a preheated sheet of silicone material to accelerate curing time as noted in step 78. Then, lower inner skin 24 is laid over lower outer skin 22, represented in step 80, and the shaped product blank 26 is inserted into the cavity represented in step 82. Lay up skin 32 is then inserted into all internal strength member cavities indicated in step 84 and the core material 34 is inserted into all strength members as noted in step 86. Upper inner skin 38 is next laid over the shaped product blank 26 as represented in step 88, with upper outer skin 40 laid over upper inner skin 38 and shaped product blank 26, represented in step 90. An option of using a preheated sheet of silicone material to accelerate curing time is noted in step 92. Next, upper cassette 42 is placed over product assembly 20 and lower cassette 12, represented in step 94, and placed between lower mold jaw 100 and upper mold jaw 104, noted in step 96. Pressure is then applied to form cassette assembly package 60 into the desired shape and finally cassette assembly package is left to cure, represented in step 98.

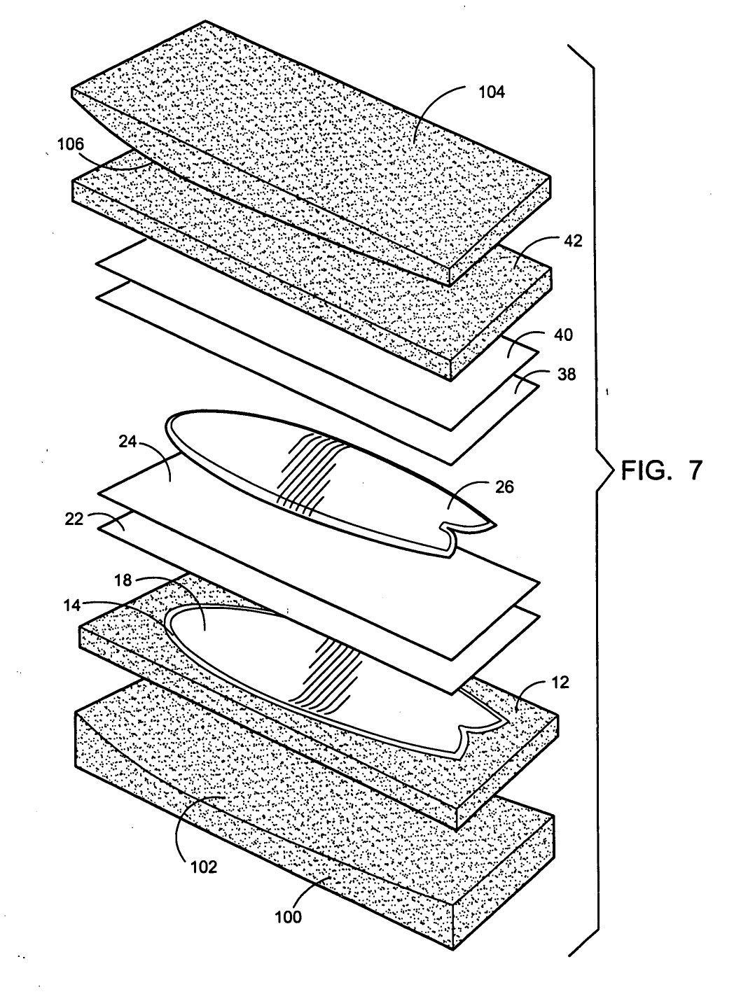

As illustrated in FIG. 7, there is seen an exploded perspective view of the elements used in the fabrication of a sports board, including lower mold jaw 100 containing a negative curvature 102, lower cassette 12 having a lower female impression 18, and lower cassette closeout 14. Lower outer skin 22 and lower inner skin 24 are positioned below product blank 26. Upper inner skin 38 and upper outer skin 40 are positioned above product blank 26 and below upper cassette 42. Upper mold jaw 104 is shown with a positive curve 106, although it must be understood that a wide variety of contours and shapes may occur in the configuration of the mold jaws 100 and 104 and still be covered within the scope of the present invention.

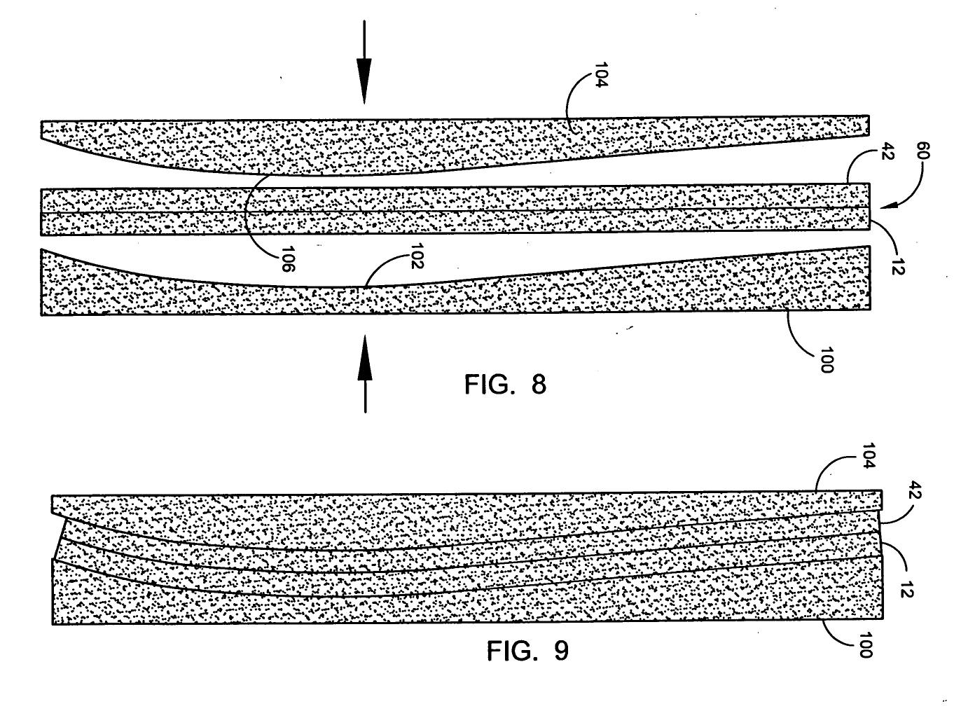

As illustrated in FIG. 8, there is seen an exploded side view of cassette assembly package 60 between lower mold jaw 100 and upper mold jaw 104. Pressure, as indicated by the arrows shown, is applied lower mold jaw 100 and upper mold jaw 104 to shape cassette assembly package 60 (see FIG. 9).

As illustrated in FIG. 9, there is seen a side view of cassette assembly package 60 compressed between lower mold jaw 100 and upper mold jaw 104.

As illustrated in FIG. 10, there is seen an exploded view of product blank 26 with a central segment 108 removed and divided into an upper portion 110 and a lower portion 112.

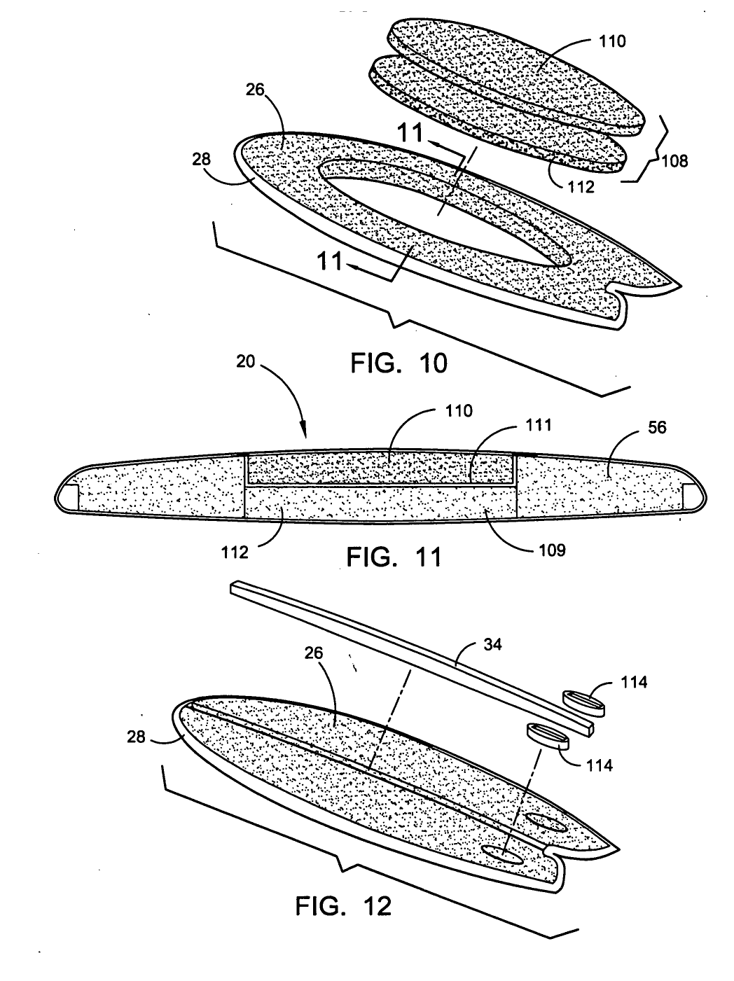

As illustrated in FIG. 11, there is seen a cross-section side view of product assembly 20 with a centrally located large strength member 109. Centrally located large strength member 109 is comprised of strength member 111 positioned between upper portion 110 and lower portion 112.

As illustrated in FIG. 12, there is seen an exploded view of product blank 26 with a typical stringer core 34 and skeg mounts 114

The polymer molding process 10 shown in the drawings and described in detail herein disclose arrangements of elements of particular construction and configuration for illustrating the method of fabrication in the present invention. It is to be understood, however, that elements of different construction and configuration and other arrangements thereof, other than those illustrated and described may be employed for providing additional polymer molding processes 10 in accordance with the spirit of this invention, and such changes, alternations and modifications as would occur to those skilled in the art are considered to be within the scope of this invention as broadly defined in the appended claims.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A method for molding a variety of polymer structures with varying flexibility characteristics comprising the steps of:
a) designing a product using computer aided design software and flattening said product digitally, routing the inside edge of the perimeter of said product in a product blank, routing the outside edge of the perimeter of said product in two cassette halves, and inserting closeout material into the routed areas of said product blank and said cassette halves;
b) shaping said product blank, shaping said cassette halves with a female image of said product, placing outer skin material for said product in the female image of a first of said cassette halves, and placing inner skin material for said product in the female image of said first of said cassette halves;
c) inserting the shaped product blank in the female image of said first of said cassette halves, and placing inner skin material over said shaped product blank, placing outer skin material over said inner skin material and said shaped product blank; and
d) placing a second of said cassette halves over said outer skin material and said shaped product blank, thereby forming a cassette package in combination with said first of said cassette halves, placing said cassette package between contoured molded jaws, and applying pressure to said cassette package for the purpose of forming said cassette package into a desired product shape.

2. The method for molding a variety of polymer structures with varying flexibility characteristics of claim 1, wherein said step of inserting closeout material into the routed areas of said product blank and said cassette halves, includes pouring liquid or paste closeout material into said routed areas.

3. The method for molding a variety of polymer structures with varying flexibility characteristics of claim 1, further comprising the step of routing or hot wire cutting said product blank for the purpose of creating an area for placement of any internal structural members within said product blank, after said step of routing the outside edge of the perimeter of said product in two cassette halves.

4. The method for molding a variety of polymer structures with varying flexibility characteristics of claim 1, wherein said step of placing outer skin material for said product in the female image of a first of said cassette halves is replaced with the step of placing preheated silicone material in the female image of a first of said cassette halves for the purpose of accelerating curing time.

5. The method for molding a variety of polymer structures with varying flexibility characteristics of claim 1, further comprising the step of inserting core into all internal strength members after said step of inserting the shaped product blank in the female image of said first of said cassette halves.

6. The method for molding a variety of polymer structures with varying flexibility characteristics of claim 1, wherein said step of placing outer skin material over said inner skin material and said shaped product blank is replaced with the step of placing preheated silicone material over said inner skin material and said shaped product blank for the purpose of accelerating curing time.

7. The method for molding a variety of polymer structures with varying flexibility characteristics of claim 1, further comprising the step of allowing said desired product shape to cure after said step of applying pressure to said cassette package for the purpose of forming said cassette package into a desired product shape.

8. A method for molding a variety of polymer structures with varying flexibility characteristics comprising the steps of:
a) designing a product using computer aided design software and flattening the product digitally, routing the inside edge of the perimeter of said product in a product blank, routing the outside edge of the perimeter of said product in two cassette halves, and routing or hot wire cutting said product blank for the purpose of creating an area for placement of any internal structural members within said product blank;
b) inserting closeout material into the routed areas of said product blank and said cassette halves;
c) shaping said product blank, shaping said cassette halves with a female image of said product, placing outer skin material for said product in the female image of a first of said cassette halves, placing inner skin material for said product in the female image of said first of said cassette halves, and inserting the shaped product blank in the female image of said first of said cassette halves;
d) placing inner skin material over said shaped product blank, placing outer skin material over said inner skin material and said shaped product blank, placing a second of said cassette halves over said outer skin material and said shaped product blank, thereby forming a cassette package in combination with said first of said cassette halves, and placing said cassette package between contoured molded jaws; and
e) applying pressure to said cassette package for the purpose of forming said cassette package into a desired product shape and curing said desired product shape.

9. The method for molding a variety of polymer structures with varying flexibility characteristics of claim 8, wherein said step of inserting closeout material into the routed areas of said product blank and said cassette halves, includes pouring liquid or paste closeout material into said routed areas.

10. The method for molding a variety of polymer structures with varying flexibility characteristics of claim 8, wherein said step of placing outer skin material for said product in the female image of a first of said cassette halves is replaced with the step of placing preheated silicone material in the female image of a first of said cassette halves for the purpose of accelerating curing time.

11. The method for molding a variety of polymer structures with varying flexibility characteristics of claim 8, wherein said step of placing outer skin material over said inner skin material and said shaped product blank is replaced with the step of placing preheated silicone material over said inner skin material and said shaped product blank for the purpose of accelerating curing time.

12. The method for molding a variety of polymer structures with varying flexibility characteristics of claim 8, further comprising the step of inserting core into all internal strength members after said step of inserting the shaped product blank in the female image of said first of said cassette halves.

13. A sports board with varying flexibility characteristics produced by the process comprising the steps of:
a) designing the sports board using computer aided design software and flattening the sports board digitally, and routing the inside edge of the perimeter of the sports board in a product blank;
b) routing the outside edge of the perimeter of the sports board in two cassette halves;
c) inserting closeout material into the routed areas of said product blank and said cassette halves;
d) shaping said product blank, shaping said cassette halves with a female image of the sports board, placing outer skin material for said product in the female image of a first of said cassette halves, placing inner skin material for said product in the female image of said first of said cassette halves, inserting the shaped product blank in the female image of said first of said cassette halves, placing inner skin material over said shaped product blank, and placing outer skin material over said inner skin material and said shaped product blank; and
e) placing a second of said cassette halves over said outer skin material and said shaped product blank, thereby forming a cassette package in combination with said first of said cassette halves, placing said cassette package between contoured molded jaws, and applying pressure to said cassette package for the purpose of forming said cassette package into a desired product shape.

14. A sports board with varying flexibility characteristics produced by the process of claim 13 further comprising the step of routing or hot wire cutting said product blank for the purpose of creating an area for placement of an internal structural member within said product blank, after said step of routing the outside edge of the perimeter of said product in two cassette halves.

15. A sports board with varying flexibility characteristics produced by the process of claim 14, wherein said internal structural member is a stringer core.

16. A sports board with varying flexibility characteristics produced by the process of claim 15, wherein said stringer core is comprised of a material selected from the group consisting of polypropylene foam, polyethylene foam, Styrofoam, poly vinyl chloride foam, urethane foam, and epoxy foam.

17. A sports board with varying flexibility characteristics produced by the process of claim 13, wherein said step of placing outer skin material for said product in the female image of a first of said cassette halves is replaced with the step of placing preheated silicone material in the female image of a first of said cassette halves for the purpose of accelerating curing time.

18. A sports board with varying flexibility characteristics produced by the process of claim 13, further comprising the step of inserting core into all internal strength members after said step of inserting the shaped product blank in the female image of said first of said cassette halves.

19. A sports board with varying flexibility characteristics produced by the process of claim 13, wherein said step of placing outer skin material over said inner skin material and said shaped product blank is replaced with the step of placing preheated silicone material over said inner skin material and said shaped product blank for the purpose of accelerating curing time.

20. A sports board with varying flexibility characteristics produced by the process of claim 13 further comprising the step of allowing said desired product shape to cure after said step of applying pressure to said cassette package for the purpose of forming said cassette package into a desired product shape.

21. A sports board with varying flexibility characteristics produced by the process of claim 13, wherein said outer skin material is selected from the group consisting of ethylene vinyl acetate, polyethylene, poly vinyl chloride, and polyester.

22. A sports board with varying flexibility characteristics produced by the process of claim 13, wherein said inner skin material is comprised of a fiber-reinforced thermal plastic selected from the group consisting of poly vinyl chloride, acrylonitrile butadiene styrene, polycarbonate, and polyethylene.

23. A sports board with varying flexibility characteristics manufactured from a flat product blank comprising:
a) an elongated and substantially flat core member containing a circumferential groove;
b) a segment of impermeable material located within said groove, said segment of impermeable material comprised of a different density than said core member; and
c) one or more layers of composite material surrounding said core member for the purpose of strengthening and protecting said core member.

24. The sports board with varying flexibility characteristics manufactured from a flat product blank of claim 23, wherein said core member contains at least one internal structural member.

25. The sports board with varying flexibility characteristics manufactured from a flat product blank of claim 24, wherein said at least one internal structural member is a stringer core.

26. The sports board with varying flexibility characteristics manufactured from a flat product blank of claim 23, wherein said core member contains one or more fixtures for mounting skegs and a leash.

27. The sports board with varying flexibility characteristics manufactured from a flat product blank of claim 23, wherein said core member contains an elongated and substantially flat central region having different flexibility characteristics than said core member.

28. The sports board with varying flexibility characteristics manufactured from a flat product blank of claim 27, wherein said central region comprises at least two elongated and substantially flat sections of material, each of said sections of material having different flexibility characteristics.

29. The sports board with varying flexibility characteristics manufactured from a flat product blank of claim 23, wherein at least one of said one or more layers of composite material surrounding said core member is selected from the group consisting of ethylene vinyl acetate, polyethylene, poly vinyl chloride, and polyester.

30. The sports board with varying flexibility characteristics manufactured from a flat product blank of claim 23, wherein at least one of said one or more layers of composite material surrounding said core member is comprised of a fiber-reinforced thermal plastic selected from the group consisting of poly vinyl chloride, acrylonitrile butadiene styrene, polycarbonate, and polyethylene.
